(19) United States
(12) Patent Application Publication
(10) Pub. No.: US 2008/0034557 A1
(43) Pub. Date: Feb. 14, 2008

(54) Strap reel

(76) Inventor: Glen R. Taylor, Benton, MO (US)

Correspondence Address: STRATTON BALLEW, 213 S 12TH AVE, YAKIMA, WA, 98902, US

(21) Appl. No.: 11/890,773

(22) Filed: Aug. 6, 2007

Related U.S. Application Data
(60) Provisional application No. 60/836,732, filed on Aug. 9, 2006.

(51) Int. Cl. B60R 9/00

(52) U.S. Cl. 24/132 R

(57) ABSTRACT

A strap reel for winding load securing straps is comprised of a circular base, an arbor, and a protruding element. The arbor is centered on a first side of the circular base, and is adapted to be received by a motorized drill. The protruding element is centered on the opposing side of the circular base, and is configured to receive the hook of the strap. The strap reel provides an easy and quick way to wind straps for storage.

### CROSS-REFERENCE TO RELATED APPLICATIONS

This application claims priority of prior U.S. provisional application Ser. No. 60/836732, filed Aug. 9, 2006.

### BACKGROUND OF THE INVENTION

The use of binder or otherwise called ratchet straps to secure loads on a flatbed trailer, whether being a small utility type or a semi tractor trailer, are common place. These straps are long and difficult to roll up. This process is time consuming; the straps are rolled up by hand or put on a reel with a handle and wound up manually. The strap reel of the present invention is powered by a cordless drill that speeds and simplifies the process of rolling up the strap for storage.

### SUMMARY OF THE INVENTION

The strap reel is comprised of a round base and centered one side is an arbor that connects to the cordless drill, on the opposite side of the said base is a protruding element to fasten the strap and to roll the strap around. The present invention will enable drivers of semi tractor trailer rigs an easy and quick way to roll up straps used to tie down loads. These drivers are on tight schedules and saving time is important.

### DESCRIPTION OF DRAWINGS

FIG. 1 A side view.

FIG. 2 A perspective view.

### DETAILED DESCRIPTION OF INVENTION

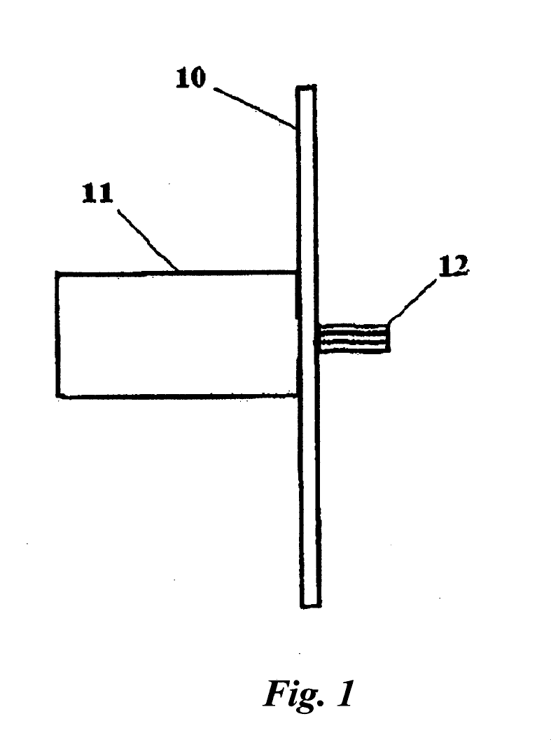

As shown in FIG. 1, the base (10) is round with a diameter of approximately eight inches and comprised of hard molded plastic approximately one quarter inch thick.

Centered on the side of said base is an arbor (12) for connection to a cordless drill.

Still referring to FIG. 1, centered on the opposite side of the base (10) is a protruding element (11) approximately three inches long, two and a half inches wide made from the same said plastic, that provides means to attach the hook end of a ratchet strap.

The three sections (10), (11), (12) may be one solid unit comprised of plastic poured into a mold, or each section cut from a sheet of plastic and connected by bolts and screws.

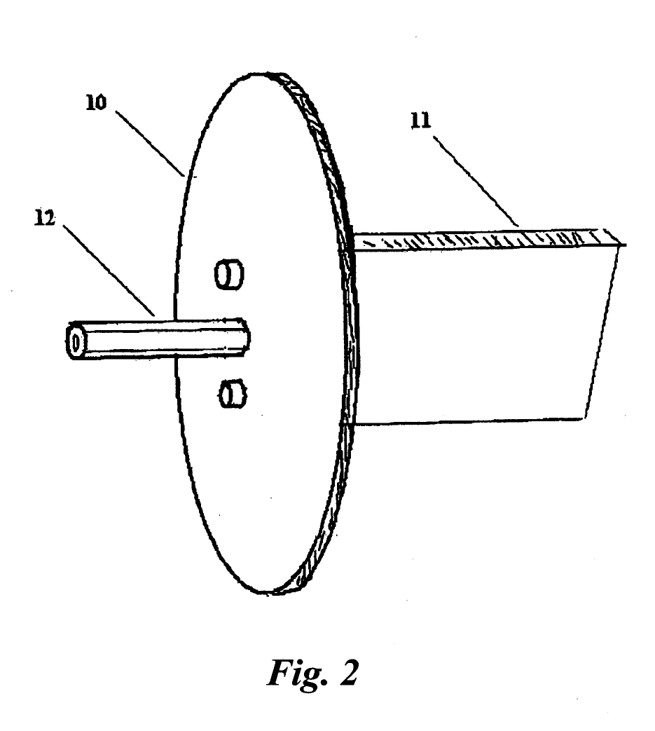

The view in FIG. 2 shows more in detail the elements comprising the strap reel.

Mode of Operation

Place the end of the ratchet strap with the hook over the protruding element (11). Then connect the arbor (12) to a cordless drill, when the drill is turned on the strap reel spins and rolls up the strap. The strap may then be removed and put into storage.

I claim:

1. A strap reel for winding a load securing strap comprising a strap and a hook affixed to the strap, the strap reel comprising:
a base, the base having a substantially circular shape, and the base having a first side and an opposing side.
an arbor, the arbor centered on and extending substantially perpendicularly from the first side of the base, the arbor adapted to be engaged in a motorized drill; and
a protruding element, the protruding element centered on and extending substantially perpendicularly from the opposing side of the base, the protruding element for receiving the hook of the load securing strap.

2. A method for winding a load securing strap for storage using a strap reel and a motorized drill, the load securing strap comprising a strap and a hook affixed to the strap, and the strap reel comprising a base having a first side and an opposing side, an arbor, the arbor centered on and extending substantially perpendicularly from the first side of the base, the arbor adapted to be engaged in a motorized drill, and a protruding element, the protruding element centered on and extending substantially perpendicularly from the opposing side of the base, the protruding element for receiving the hook of the load securing strap, the method including the steps of:
Engaging the hook of the load securing strap on the protruding element;
Engaging the arbor of the strap reel in the motorized drill; and,
Activating the drill to turn the strap reel and wind the strap onto the protruding element.
